(19) United States
(12) Patent Application Publication
(10) Pub. No.: US 2014/0071656 A1
(43) Pub. Date: Mar. 13, 2014

(54) LIGHT SOURCE MODULE AND BULB LAMP

(71) Applicants: Tzyy-Jang Tseng, Hsinchu (TW); Cheng-Yi Wang, Hsinchu (TW); Yung-Cheng Sung, Hsinchu City (TW); Chung-Pan Wu, Hsinchu (TW)

(72) Inventors: Tzyy-Jang Tseng, Hsinchu (TW); Cheng-Yi Wang, Hsinchu (TW); Yung-Cheng Sung, Hsinchu City (TW); Chung-Pan Wu, Hsinchu (TW)

(73) Assignee: APM COMMUNICATION, INC., Hsinchu (TW)

(21) Appl. No.: 13/742,350

(22) Filed: Jan. 16, 2013

(30) Foreign Application Priority Data
Sep. 12, 2012 (TW) 101133360

(51) Int. Cl. F21V 21/00

(52) U.S. Cl. CPC F21V 21/00
USPC 362/84; 362/249.06

(57) ABSTRACT

A light source module includes a base plate, a projection, and a plurality of light-emitting devices. The projection is disposed on the base plate. The light-emitting devices surround the projection and are disposed on the projection.

### CROSS-REFERENCE TO RELATED APPLICATION

This application claims the priority benefit of Taiwan application serial no. 101133360, filed on Sep. 12, 2012. The entirety of the above-mentioned patent application is hereby incorporated by reference herein and made a part of this specification.

### BACKGROUND OF THE INVENTION

1. Field of the Invention

The invention relates to a light source module and a bulb lamp, and more particularly to a light source module and a bulb lamp capable of emitting light at a large angle.

2. Description of Related Art

A light-emitting diode (LED) is a semiconductor device, and a material of a light-emitting chip thereof is mainly selected from a compound of group III-V chemical elements, such as gallium phosphide (GaP), gallium arsenide (GaAs), and so on. Besides, the LED emits light through the conversion of electric energy into optical energy. The lifespan of the LED often reaches or even exceeds 100,000 hours, and the LED is characterized by high responsive speed, small volume, low power consumption, low degree of pollution, great reliability, adaptation of mass production, etc. Thus, the LED has been extensively applied in the field of illumination lamps.

The conventional incandescent light bulb emits light at a relatively large angle, while the normal LED bulb lamp is subject to the limited light-emitting angle and thus is not able to emit light at a large angle. This results in the uneven brightness of the LED bulb lamp.

### SUMMARY OF THE INVENTION

The invention is directed to a light source module that may emit light at a large angle.

The invention is directed to bulb lamp featuring uniform brightness.

In the invention, a light source module that includes a base plate, a projection, and a plurality of light-emitting devices is provided. The projection is disposed on the base plate. The light-emitting devices surround the projection and are disposed on the projection.

According to an embodiment of the invention, a shape of the projection in the light source module is a monohedron or a polyhedron, for instance.

According to an embodiment of the invention, a shape of the projection in the light source module is a hemisphere, a prism, a pyramid, a column, or a cone, for instance.

According to an embodiment of the invention, the projection and the base plate in the light source module may be integrally formed or individually formed.

According to an embodiment of the invention, each of the light-emitting devices in the light source module is a light-emitting diode (LED) light source, for instance.

According to an embodiment of the invention, the LED light source in the light source module is a chip-on-board (COB) type LED light source or a surface-mount-technology (SMT) type LED light source, for instance.

According to an embodiment of the invention, the light source module further includes a lampshade that covers the light-emitting devices.

According to an embodiment of the invention, the lampshade in the light source module is a mask that has phosphor or diffusion particles, for instance.

In an embodiment of the invention, a bulb lamp that includes a lamp housing and a light source module is provided. The light source module includes a base plate, a projection, and a plurality of light-emitting devices. The base plate is disposed on the lamp housing. The projection is disposed on the base plate. The light-emitting devices surround the projection and are disposed on the projection.

According to an embodiment of the invention, the lamp housing in the bulb lamp is a heat dissipation lamp housing, for instance.

According to an embodiment of the invention, a shape of the projection in the bulb lamp is a monohedron or a polyhedron, for instance.

According to an embodiment of the invention, a shape of the projection in the bulb lamp is a hemisphere, a prism, a pyramid, a column, or a cone, for instance.

According to an embodiment of the invention, the projection and the base plate in the bulb lamp may be integrally formed or individually formed.

According to an embodiment of the invention, each of the light-emitting devices in the bulb lamp is an LED light source, for instance.

According to an embodiment of the invention, the LED light source in the bulb lamp is a COB type LED light source or a SMT type LED light source, for instance.

According to an embodiment of the invention, the bulb lamp further includes at least one connection component that fixes the base plate onto the lamp housing.

According to an embodiment of the invention, the bulb lamp further includes a lamp base that is connected to the lamp housing.

According to an embodiment of the invention, the light source module in the bulb lamp further includes a lampshade that covers the light-emitting devices.

According to an embodiment of the invention, the lampshade in the bulb lamp is a mask that has phosphor or diffusion particles, for instance.

In view of the above, the light-emitting devices of the light source module surround the projection and are disposed on the projection. Therefore, the light-emitting devices may emit light at different locations of the projection, and the light source module is thus allowed to emit light at a large angle. In addition, the bulb lamp described in an embodiment of the invention employs the aforesaid light source module capable of emitting light at a large angle, and thus the bulb lamp provided herein will not encounter the issue of uneven brightness.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an exploded view illustrating a light source module according to an embodiment of the invention.

FIG. 2 is an assembled view illustrating the light source module depicted in FIG. 1.

FIG. 3 is an exploded view illustrating a bulb lamp according to an embodiment of the invention.

FIG. 4 is an assembled view illustrating the bulb lamp depicted in FIG. 3.

FIG. 5 is a three-dimensional top view illustrating the base plate and the projection depicted in FIG. 3.

FIG. 6 is a three-dimensional bottom view illustrating the base plate and the projection depicted in FIG. 3.

### DESCRIPTION OF EMBODIMENTS

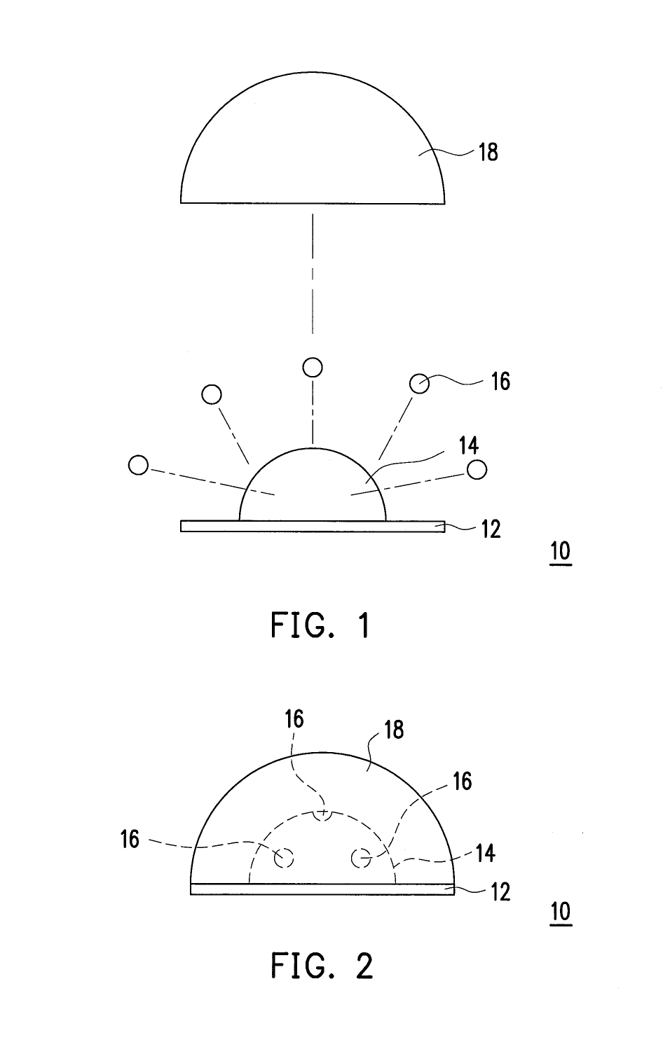

FIG. 1 is an exploded view illustrating a light source module according to an embodiment of the invention. FIG. 2 is an assembled view illustrating the light source module depicted in FIG. 1.

With reference to FIG. 1 and FIG. 2, the light source module 10 includes a base plate 12, a projection 14, and a plurality of light-emitting devices 16. The base plate 12 is made of aluminum, copper, and so on, for instance.

The projection 14 is disposed on the base plate 12. Besides, the projection 14 may be shaped as a monohedron or a polyhedron. For instance, the projection 14 may be shaped as a hemisphere, a prism, a pyramid, a column, or a cone. In the present embodiment, the projection 14 is an exemplary hemispheric monohedron, which should however not be construed as a limitation to the invention. As long as the projection 14 is shaped as a three-dimensional protrusion, the projection 14 falls within the scope of the invention and does not depart from the spirit of the invention. According to an embodiment of the invention, the projection 14 and the base plate 12 in the light source module 10 are integrally formed or individually formed, for instance. In the present embodiment, the projection 14 and the base plate 12 are integrally formed, for instance, and this should by no means restrict the scope of the invention. In another embodiment of the invention, the projection 14 and the base plate 12 may also be individually formed, and then the projection 14 may be disposed on the base plate 12 through a bonding method, e.g., a welding process.

The light-emitting devices 16 surround the projection 14 and are disposed on the projection 14. Therefore, the light-emitting devices 16 may emit light at different locations of the projection 14, and the light source module 10 is thus allowed to emit light at a large angle. According to an embodiment of the invention, the light-emitting devices 16 in the light source module 10 are light-emitting diode (LED) light sources, for instance. The LED light sources are, for instance, chip-on-board (COB) type LED light sources or surface-mount-technology (SMT) type LED light sources. In the present embodiment, there are five light-emitting devices 16, for instance, which should however not be construed as a limitation to the invention. As long as the number of the light-emitting devices 16 is two or more, the light-emitting devices 16 fall within the scope of the invention and do not depart from the spirit of the invention. People having ordinary skill in the pertinent art may, based on actual product design requirements, adjust the number and the locations of the light-emitting devices 16, such that the light source module 10 is allowed to emit light at a large angle.

The light source module 10 may optionally include a lampshade 18. The lampshade 18 covers and protects the light-emitting devices 16. Additionally, the lampshade 18 is disposed on the base plate 12, for instance, and the lampshade 18 is made of polycarbonate (PC), polymethyl methacrylate (PMMA), or glass, for instance.

Here, the lampshade 18 may be a mask that contains diffusion particles, such that the lampshade 18 may serve as a diffusion mask. Since the lampshade 18 has the diffusion particles, the lampshade 18 not only may prevent the glare but also can further improve uniformity of light emitted from the light source module 10.

Given that the light-emitting devices 16 of the light source module 10 are the LED light sources, the lampshade 18 may be a mask with phosphor. Since the lampshade 18 has the phosphor, the optical properties (e.g., color or color temperature) of the light emitted from the light source module 10 may be adjusted by means of the phosphor in the lampshade 18. Moreover, the phosphor in the lampshade 18 may also be applied to prevent glare and improve light uniformity of the light source module 10.

In light of the previous embodiments, the light-emitting devices 16 in the light source module 10 surround the projection 14 and are disposed on the projection 14; therefore, the light source module 10 is allowed to emit light at a large angle due to the fact that the light-emitting devices 16 are placed at different locations of the projection 14.

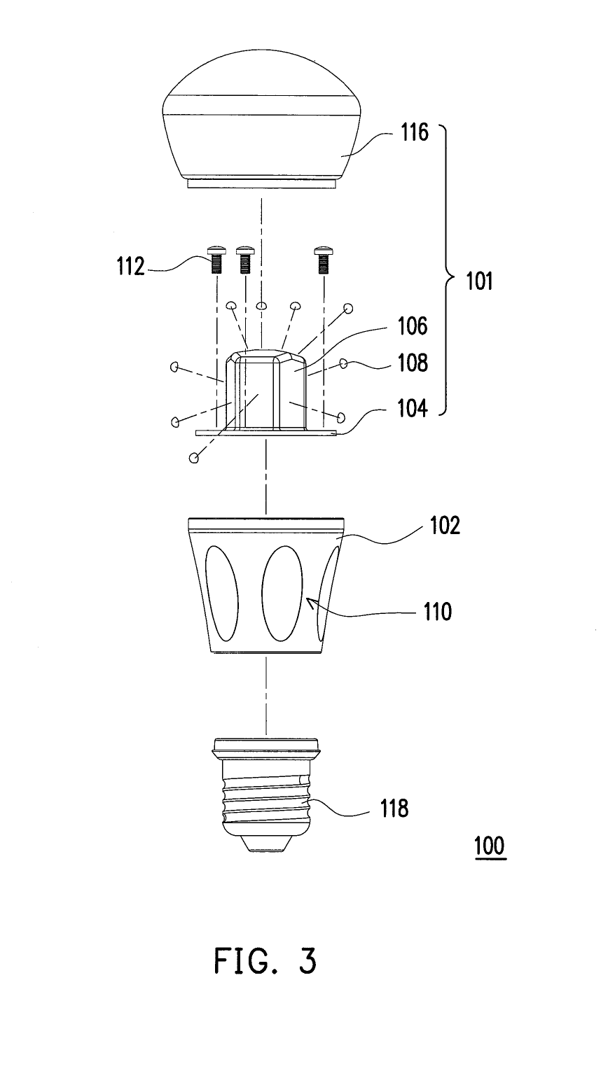

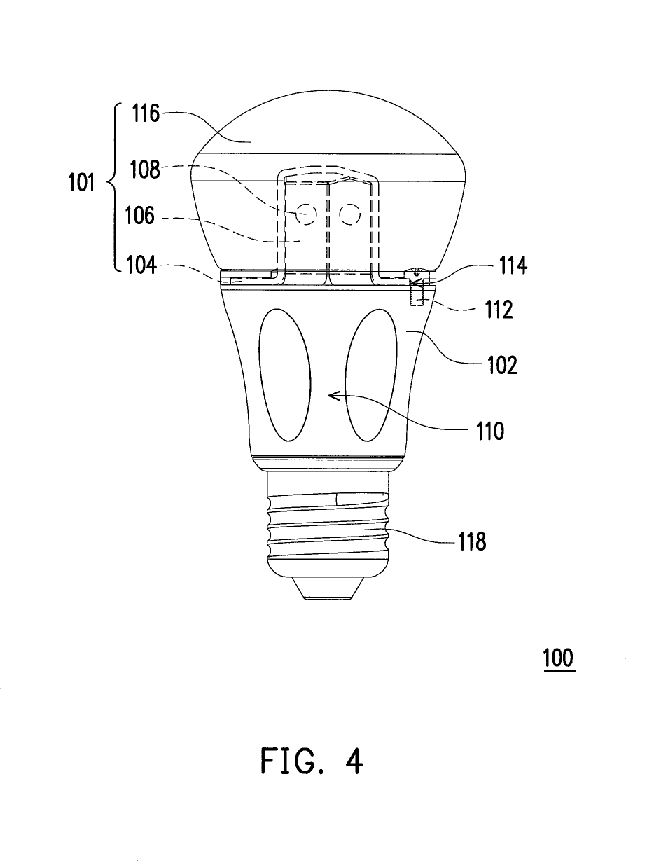

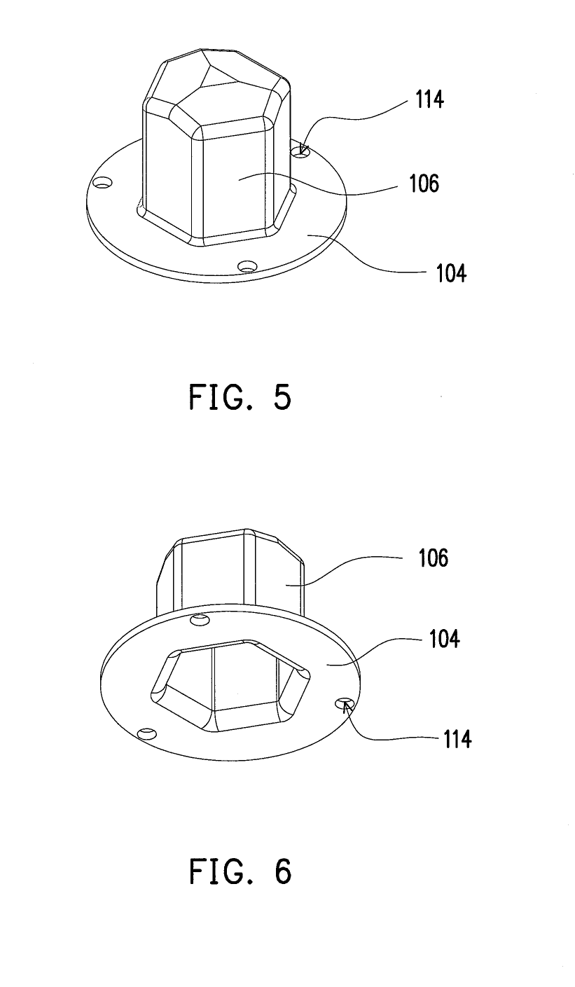

FIG. 3 is an exploded view illustrating a bulb lamp according to an embodiment of the invention. FIG. 4 is an assembled view illustrating the bulb lamp depicted in FIG. 3. FIG. 5 is a three-dimensional top view illustrating the base plate and the projection depicted in FIG. 3. FIG. 6 is a three-dimensional bottom view illustrating the base plate and the projection depicted in FIG. 3.

With reference to FIG. 3 to FIG. 6, the bulb lamp 100 includes a lamp housing 102 and a light source module 101. The lamp housing 102, for instance, is a heat dissipation lamp housing and may have a plurality of heat dissipation fins 110, which may prevent the performance degradation of the bulb lamp 100 caused by overheat. The lamp housing 102 is made of aluminum, copper, and so on, for instance.

The light source module 101 includes a base plate 104, a projection 106, and a plurality of light-emitting devices 108. The base plate 104 is disposed on the lamp housing 102. The base plate 104 is made of aluminum, copper, and so on, for instance. Here, the base plate 104 and the lamp housing 102 may be integrally formed or individually formed. Given that the base plate 104 and the lamp housing 102 are individually formed, the bulb lamp 100 further includes at least one connection component 112 that fixes the base plate 104 onto the lamp housing 102. The connection component 112 is a screw, for instance, which should however not be construed as a limitation to the invention. Any component that may fix the base plate 104 onto the lamp housing 102 may serve as the connection component 112 described in the present embodiment. In addition, when the connection component 112 is a screw, the base plate 104 has a threaded hole 114, such that the connection component 112 may pass through the threaded hole 114 and fix the base plate 104 onto the lamp housing 102.

The projection 106 is disposed on the base plate 104. Besides, the projection 106 is shaped as a monohedron or a polyhedron, for instance. For instance, the projection 106 may be shaped as a hemisphere, a prism, a pyramid, a column, or a cone. In the present embodiment, the projection 106 is an exemplary polyhedron, a bottom of which is a hexagon. However, this should not be construed as a limitation to the invention. As long as the projection 106 is shaped as a three-dimensional protrusion, the projection 106 falls within the scope of the invention and does not depart from the spirit of the invention. According to an embodiment of the invention, the projection 106 and the base plate 104 in the bulb lamp 100 are integrally formed or individually formed, for instance. In the present embodiment, the projection 106 and the base plate 104 are integrally formed, for instance, and this should by no means restrict the scope of the invention. In another embodiment of the invention, the projection 106 and the base plate 104 may also be individually formed, and then the projection 106 may be disposed on the base plate 104 through a bonding method, e.g., a welding process.

The light-emitting devices 108 surround the projection 106 and are disposed on the projection 106. Therefore, the light-emitting devices 108 may emit light at different locations of the projection 106, and the bulb lamp 100 is thus allowed to emit light at a large angle. According to an embodiment of the invention, the light-emitting devices 108 in the bulb lamp 100 are LED light sources, for instance. The LED light sources are, for instance, COB type LED light sources or SMT type LED light sources. In the present embodiment, there are nine light-emitting devices 108, for instance, wherein six of the light-emitting devices 108 are respectively located on six side surfaces of the projection 106, and the other three of the light-emitting devices 108 are respectively located on three top surfaces of the projection 106. Nevertheless, this should not be construed as a limitation to the invention. As long as the number of the light-emitting devices 108 is two or more, the light-emitting devices 108 fall within the scope of the invention and do not depart from the spirit of the invention. People having ordinary skill in the pertinent art may, based on actual product design requirements, adjust the number and the locations of the light-emitting devices 108, such that the bulb lamp 100 is allowed to emit light at a large angle, and has uniform brightness.

The light source module 101 may optionally include a lampshade 116. The lampshade 116 is disposed on the other side of the lamp housing 102, and the lampshade 116 covers and protects the light-emitting devices 108. Here, the lampshade 18 is made of PC, PMMA, or glass, for instance.

The bulb lamp 100 may further include a lamp base 118 that is connected to one side of the lamp housing 102, so that the bulb lamp 100 may be connected to an external power supply. The lamp base 118 is made of a metal material, e.g., copper.

In light of the previous embodiments, the bulb lamp 100 is equipped with the light source module 101, and the light-emitting devices 108 in the light source module 101 surround the projection 106 and are disposed on the projection 106; therefore, the light-emitting angle of the light source module 101 may be widened on account of the fact that the light-emitting devices 108 are placed at different locations of the projection 106. As such, the bulb lamp 100 may emit light at a large angle, and may have uniform brightness.

To sum up, the light source module and the bulb lamp described in the previous embodiments at least have the following properties. The light source module described above may emit light at a relatively large angle. Moreover, the bulb lamp provided in the previous embodiments may have uniform brightness.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A light source module comprising:
a base plate;
a projection disposed on the base plate; and
a plurality of light-emitting devices surrounding the projection and disposed on the projection.

2. The light source module as recited in claim 1, wherein a shape of the projection comprises a monohedron or a polyhedron.

3. The light source module as recited in claim 1, wherein a shape of the projection comprises a hemisphere, a prism, a pyramid, a column, or a cone.

4. The light source module as recited in claim 1, wherein the projection and the base plate are integrally formed or individually formed.

5. The light source module as recited in claim 1, wherein each of the light-emitting devices comprises a light-emitting diode light source.

6. The light source module as recited in claim 5, wherein the light-emitting diode light source comprises a chip-on-board type light-emitting diode light source or a surface-mount-technology type light-emitting diode light source.

7. The light source module as recited in claim 1, further comprising a lampshade covering the light-emitting devices.

8. The light source module as recited in claim 7, wherein the lampshade comprises a mask having phosphor or diffusion particles.

9. A bulb lamp comprising:
a lamp housing; and
a light source module comprising:
a base plate disposed on the lamp housing;
a projection disposed on the base plate; and
a plurality of light-emitting devices surrounding the projection and disposed on the projection.

10. The bulb lamp as recited in claim 9, wherein the lamp housing comprises a heat dissipation lamp housing.

11. The bulb lamp as recited in claim 9, wherein a shape of the projection comprises a monohedron or a polyhedron.

12. The bulb lamp as recited in claim 9, wherein a shape of the projection comprises a hemisphere, a prism, a pyramid, a column, or a cone.

13. The bulb lamp as recited in claim 9, wherein the projection and the base plate are integrally formed or individually formed.

14. The bulb lamp as recited in claim 9, wherein each of the light-emitting devices comprises a light-emitting diode light source.

15. The bulb lamp as recited in claim 14, wherein the light-emitting diode light source comprises a chip-on-board type light-emitting diode light source or a surface-mount-technology type light-emitting diode light source

16. The bulb lamp as recited in claim 9, further comprising at least one connection component fixing the base plate onto the lamp housing.

17. The bulb lamp as recited in claim 9, further comprising a lamp base connected to the lamp housing.

18. The bulb lamp as recited in claim 9, wherein the light source module further comprises a lampshade covering the light-emitting devices.

19. The bulb lamp as recited in claim 18, wherein the lampshade comprises a mask having phosphor or diffusion particles.
